(19) United States
(12) Patent Application Publication
(10) Pub. No.: US 2008/0025557 A1
(43) Pub. Date: Jan. 31, 2008

(54) Image forming apparatus, image forming method and record medium

(75) Inventors: Yoko Fujiwara, Tokyo (JP); Fumihito Akiyama, Tokyo (JP); Jun Kuroki, Tokyo (JP)

Correspondence Address: BUCHANAN, INGERSOLL & ROONEY PC, POST OFFICE BOX 1404, ALEXANDRIA, VA, 22313-1404, US

(73) Assignee: Konica Minolta Business Technologies, Inc., Tokyo (JP)

(21) Appl. No.: 11/700,913

(22) Filed: Feb. 1, 2007

(30) Foreign Application Priority Data
Jul. 25, 2006 (JP) 2006-202295

(51) Int. Cl. G06K 9/00

(52) U.S. Cl. 382/100

(57) ABSTRACT

Disclosed is an image forming apparatus, comprising: an image processing unit to generate multivalued data from an object included in print data in which a rendering command specifies filling of the object with a pattern, the object being subject to filling in a uniform density in the multivalued data, and to generate a bit map data which reproduces a halftone in a pseudo manner with a screen pattern from the multivalued data; and an image formation control unit to form an image on a recording medium based on the bit map data.

### CROSS-REFERENCE TO RELATED APPLICATIONS

The present U.S. patent application claims a priority under the Paris Convention of Japanese patent application No. 2006-202295 filed on Jul. 25, 2006, which shall be a basis of correction of an incorrect translation.

### BACKGROUND

1. Field of the Invention

The present invention relates to an image forming apparatus, an image forming method and a computer readable medium, and more particularly to an image forming apparatus, an image forming method and a computer readable medium for preventing the occurrence of moirécaused by the interference of bit maps.

2. Description of Related Art

It is known that an image forming apparatus such as a copying machine, a printer, a facsimile and a multi function peripheral (MFP) having those functions combined therein performs printing by means of a bit map.

When fill is printed by means of a bit map, filling area are sometimes expressed by a pattern. The pattern means a method of expressing the filling portions by, for example, a minute lattice pattern such as a checkered pattern. The pattern is also expressed by a bit map, and there has been a problem of the occurrence of moiré caused by the interference of such pattern with a ground (a bit map that has been printed on a sheet of record paper in advance) that has been subjected to dither processing or the like.

JP 2002-330289A (hereinafter referred to as Patent Document 1) discloses an image forming apparatus that prevents the occurrence of moiré caused by the interference of bit maps each having a different gradation. The image forming apparatus reads an image with a scanner or the like, and generates data (for example, image data generated in a Raster Language format) expressed as a pixel to generate bit map data. Thereafter, the image forming apparatus detects a predetermined pattern including a first pixel and a second pixel, each having a different gradation, relative to the bit map data, and converts all the pixels included in the detected pattern into a pattern consisting of the pixels each having a third gradation based on the first and second gradations to perform print processing. That is, the image forming apparatus prevents the occurrence of moiré by expressing an area expressed by a plurality of patterns, each having a different gradation, in on pattern by image processing.

However, the image forming apparatus disclosed in the Patent Document 1 is configured to process the image data input from a scanner or the like on a bit map basis. That is, because the image forming apparatus is configured to perform image processing based on the data in the form of a bit map which data is described by the Raster Language, which is nearer to the bit map, the image forming apparatus has the following problems.

The image forming apparatus described in the Patent Document 1 specifies a pattern including the first and the second gradations by performing the pattern matching of a minute area of bit map data in the processing of performing the detection of a pattern or the like. Consequently, it is apprehended that the area of an image that is occupied by a pattern cannot be accurately detected because an error of the pattern matching occurs.

Furthermore, it is apprehended that another error arises from such an error also at the time of accurately specifying the gradations of the first and the second pixels that are included in the pattern specified by the pattern matching. Consequently, it is also apprehended that the gradation of a third pixel that is generated based on the gradations of the first and the second pixels lacks exactitude, and that it becomes impossible to reproduce the gradations to be essentially expressed on a sheet of record paper.

Moreover, patterns are classified into overwriting patterns and mask patterns. The overwriting pattern is the filling method of simply overwriting a ground with a checkered pattern, for example, in the case of the pattern of a lattice pattern such as the checkered pattern consisting of white parts and black parts.

On the other hand, the mask pattern is the filling method of, for example, performing the overwriting of the ground with the black parts of the checkered pattern, while the white parts are not to be made to be white but are made to be blanks to give priority to the display of the ground. The mask pattern enables the expression of superimposing a (black) semitransparent mask on the ground.

In particular, the mask pattern has the problem of the occurrence of the moiré between the bit map of the ground expressed in the blank parts of the pattern mask and the black pattern parts. The image forming apparatus described in the Patent Document 1 prevents the moiré by performing filling processing with a finer lattice pattern, but even in this case, if the blank parts are expressed in order to give priority to the ground as the pattern mask, it is fairly apprehended that the moiré occurs.

Furthermore, the image forming apparatus disclosed in the Patent Document 1 does not function in any way to the print data to be input in an object-oriented printer language such as a page description language (PDL).

### SUMMARY

The present invention was made in order to settle the above problems. It is one of objects of the present invention to surely prevent the moiré that arises from the interference between a pattern or the like and a bit map relative to the print data input in an object-oriented printer language.

To achiever at least one of the above objects, according to an image forming apparatus reflecting one aspect of the present invention, comprises: an image processing unit to generate multivalued data from an object included in print data in which a rendering command specifies filling of the object with a pattern, the object being subject to filling in a uniform density in the multivalued data, and to generate a bit map data which reproduces a halftone in a pseudo manner with a screen pattern from the multivalued data; and an image formation control unit to form an image on a recording medium based on the bit map data.

Preferably, the image processing unit comprises: an analysis unit to change a rendering command of specifying filling with an overwriting pattern to that of specifying filling with multivalued data of uniform density, when the rendering command of specifying the filling with the pattern specifies the filling with the overwriting pattern; a multivalued data processing unit to generate the multivalued data based on the specification of the filling with the multivalued data of uniform density; and a screen processing unit to generate the bit map data which reproduces a halftone in a pseudo manner with a screen pattern from the multivalued data generated by the multivalued data processing unit.

Preferably, the uniform density is an intermediate of the overwriting pattern.

Preferably, the intermediate tone is an average tone of pixels included in the overwriting pattern.

Preferably, the image processing unit comprises: an analysis unit to change a rendering command of specifying filling with a pattern mask to that of specifying filling with multivalued data of uniform density, when the rendering command of specifying the filling with the pattern specifies the filling with the pattern mask; a multivalued data processing unit to generate the multivalued data based on the specification of the filling with the multivalued data of uniform density; and a screen processing unit to generate the bit map data which reproduces a halftone in a pseudo manner with a screen pattern from the multivalued data generated by the multivalued data processing unit.

Preferably, the uniform density is defined based on a transmittance of the pattern mask.

Preferably, the transmittance is defined based on the number of pixels which is turned on in the pattern mask.

### BRIEF DESCRIPTION OF THE DRAWINGS

These and other objects, advantages and features of the present invention will become more fully understood from the detailed description given hereinbelow and the appended drawings, and thus are not intended as a definition of the limits of the present invention, and wherein;

FIG. 1 is a flow chart showing a procedure of “PDL analysis processing” of an MFP of an embodiment of the present invention;

FIG. 2 is a schematic diagram showing the “print processing” function configuration of the MFP an embodiment of the present invention;

FIG. 3 is a schematic view showing the function units and the flows of various kinds of data relative to a control unit of the MFP an embodiment of the present invention;

FIG. 4 is a flow chart showing an outline of a procedure of the MFP of an embodiment of the present invention;

FIG. 5 is a flow chart showing the procedure of “language analysis processing” of the MFP of an embodiment of the present invention;

FIG. 6 is a flow chart showing the procedure of “rasterization processing” of the MFP in the best mode of the present invention;

FIG. 7 is a flow chart showing the procedure of “screen processing” of the MFP of an embodiment of the present invention;

FIG. 8 is a flow chart showing the procedure of “image formation processing” of the MFP of an embodiment of the present invention;

FIG. 9A is a schematic view showing a conventional input rendering command and a rendering command that is temporarily stored in a display list;

FIG. 9B is a schematic view showing a state of a conventional pattern that is expanded by a bit map;

FIG. 9C is a schematic view showing a state of the conventional bit map pattern that is pasted on a ground bit map;

FIG. 10A is a schematic view showing an input rendering command and a rendering command that is temporarily stored in a display list in the MFP of an embodiment of the present invention;

FIG. 10B is a schematic view showing a state of a pattern that is expanded by a bit map in the MFP of the present embodiment;

FIG. 10C is a schematic view showing a state of the bit map pattern that is pasted on a ground bit map in the MFP of the present embodiment;

FIG. 11A is a schematic view showing a conventional input rendering command and a rendering command that is temporarily stored in the display list;

FIG. 11B is a schematic view showing a state of the conventional pattern mask that is expanded by a bit map;

FIG. 11C is a schematic view showing a state of the bit map pattern mask that is pasted on a ground bit map;

FIG. 12A is a schematic view showing an input rendering command and a rendering command that is temporarily stored in the display list in the MFP of an embodiment of the present invention;

FIG. 12B is a schematic view showing a state of a pattern mask that is expanded by a bit map in the MFP of the present embodiment;

FIG. 12C is a schematic view showing a state of the bit map pattern mask that is pasted on the ground bit map in the MFP of the present embodiment;

FIG. 13A is a schematic view showing conventional “overwriting pattern” processing; and

FIG. 13B is a schematic view showing conventional “pattern mask” processing.

### DETAILED DESCRIPTION OF THE PREFERRED EMBODIMENTS

In the following, an MFP 1, which is a multi-functional image forming apparatus to which the present invention is applied, will be described with reference to the attached drawings. However, the scope of the invention is not limited to the shown examples.

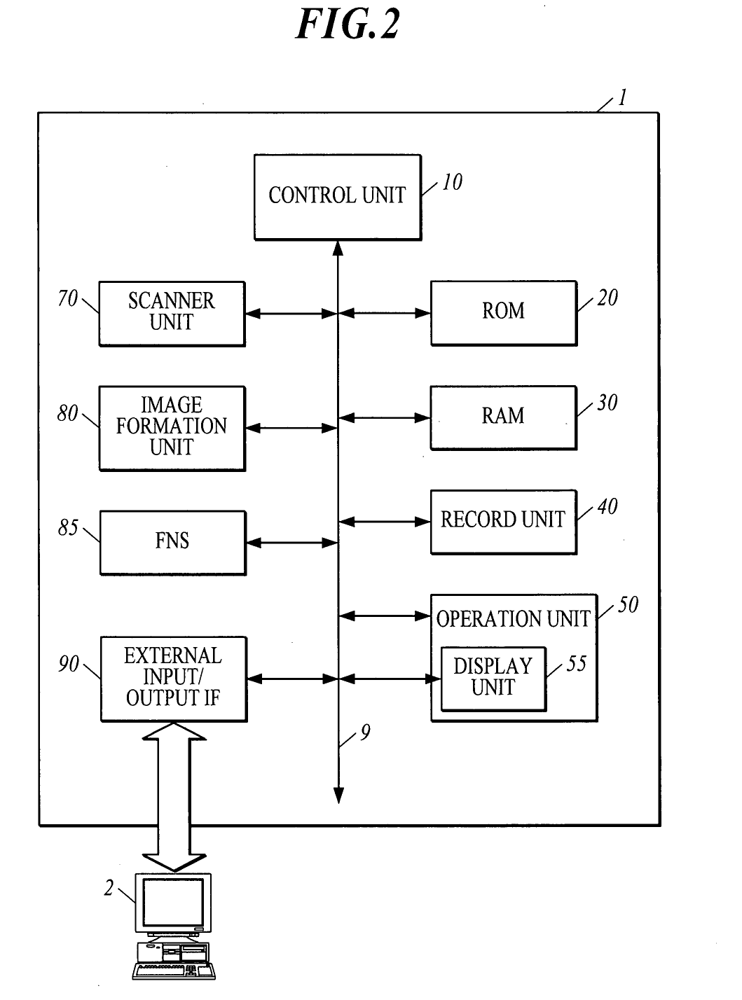

First, the outline configuration of the MFP 1 is described with reference to the block diagram shown in FIG. 2.

The MFP 1 is composed of a control unit 10, a read only memory (ROM) 20, a random access memory (RAM) 30, a record unit 40, an operation unit 50, a display unit 55, a scanner unit 70, an image formation unit 80, a finisher (FNS) 85 and an external input/output interface (IF) 90. Those components are electrically and electronically connected to one another with a bus 9. The MFP 1 has the printer function of performing image formation on a sheet of record paper based on the rendering data generated in a PDL language format input from a personal computer (PC) 2, which is an external terminal, or the rendering data generated by converting the input image data into the data having the PDL language format with a function of the MFP 1.

The control unit 10 is constructed of a central processing unit (CPU) or a micro processing unit (MPU). The control unit 10 reads an operation program and an application program that are stored in the read only memory (ROM) 20 or the record unit 40, and expands the read programs in the random access memory (RAM) 30 as a work area to perform the control of the whole operation of the MFP 1 in accordance with the instructions of the programs.

A configuration example of processing the control of the whole operation of the MFP 1 with the CPU of the control unit 10 is shown in the present embodiment, but it is naturally possible to adopt the configuration of providing a dedicated CPU to each function unit of the control unit 10, the record unit 40, the operation unit 50, the scanner unit 70 and the image formation unit 80.

The ROM 20 is constructed of a nonvolatile semiconductor memory. The ROM 20 stores the operation program of the MFP 1 and various application programs therein. The RAM 30 is constructed of a volatile or a nonvolatile semiconductor memory, and functions as a work area.

The record unit 40 is constructed of, for example, a hard disk. The record unit 40 stores the operation program, various application programs and various kinds of data such as job data in association with predetermined addresses.

The operation unit 50 is composed of a far infrared type or an electrostatic type touch panel and a hard key. The touch panel is provided to be overlaid on the display unit 55 constructed of a liquid crystal display (LCD) or the like. The display unit 55 displays various operation screens and various operation guides of the MFP 1.

The image formation unit 80 is constructed of a heretofore known image formation mechanism performing the formation of various images by electrophotographic processes or the like. The image formation unit 80 is designed to be provided with an unshown printer unit to each color of yellow (Y), magenta (M), cyan (C) and black (K), and to form an electrostatic latent image on an electrostatic drum with laser light radiated from an unshown laser unit in accordance with the rasterized image data input from the control unit 10. Each printer unit performs the development of a toner image by adhering an unshown color toner to the electrostatic latent image. After that, each printer unit transfers the toner image on a sheet of conveyed record paper to perform color image formation.

The FNS 85 is post-processing equipment performing the post-processing of sheets of record paper on which the image formation has been performed. The FNS 85 performs various kinds of post-processing such as stapling processing, sorting processing, punching processing, double folding or triple folding processing and the like to the sheets of record paper on which image formation has been performed.

The external input/output IF 90 is constructed of an interface device such as a network interface card (NIC). The external input/output IF 90 is connected to the PC 2 in the state capable of performing data communications through, for example, a local area network (LAN), a metropolitan area network (MAN), a wide area network (WAN) or the Internet. The external input/output IF 90 changes the rendering data input from the PC 2 to the data having a predetermined data format, and inputs the changed data to the control unit 10.

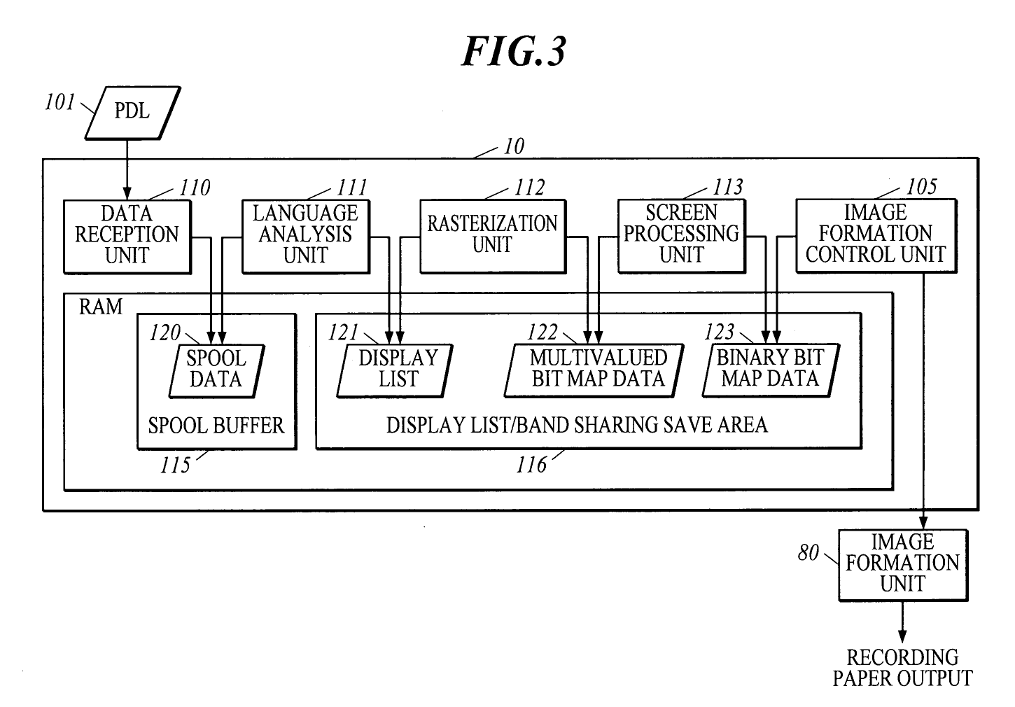

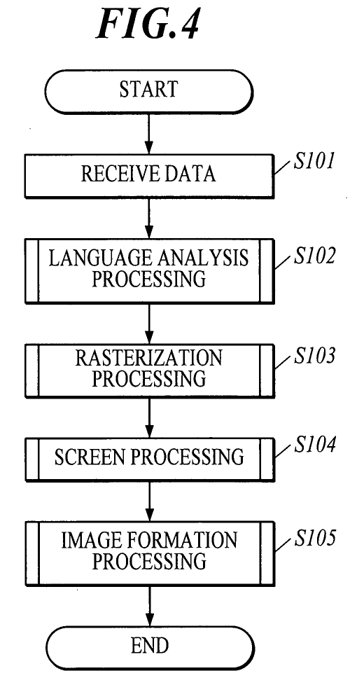

Next, the configuration of the image formation processing of the MFP 1 is described with reference to the schematic view shown in FIG. 3, and the flow charts shown in FIGS. 4-8. Each of the function units of the control unit 10, which functions in accordance with the instructions of programs data, is expressed as a data reception unit 110, a language analysis unit 111, a rasterization unit 112, a screen processing unit 113 and the image formation control unit 105, which are shown in FIG. 3. The language analysis unit 111 as an analysis unit, the rasterization unit 112 as a multivalued data processing unit, and the screen processing unit 113 among those function units constitute an image processing unit. A spool buffer 115 and a display list/band sharing save area 116 are temporarily storage areas provided in the RAM 30. PDL data 101 is rendering data described in a page description language. The configuration of inputting the PDL data 101 from the PC 2 in a PDL format, or the configuration of obtaining the PDL data 101 by converting data into the data having the PDL format by an unshown print controller in the MFP 1 may be adopted. Descriptions are given on the supposition that the rendering data of the PDL format is generated by converting the image data input from the PC 2 by the unshown print controller in the present embodiment. Moreover, various kinds of data such as spool data 120, a display list 121, multivalued bit map data 122 and binary bit map data 123 are the data generated from the PDL data 101 by each of the aforesaid function units of the control unit 10.

FIG. 4 is a flow chart showing the outline of the processing operation in each of the function units of the control unit 10. In the following, each of the function units and the processing thereof are described in detail.

### [Data Reception Unit (Step S101)]

The data reception unit 110 is the function unit that receives the PDL data 101 input from an unshown printer controller to temporarily store the received PDL data 101 into the spool buffer 115 as the spool data 120.

### [Language Analysis Unit/Language Analysis Processing (Step S102)]

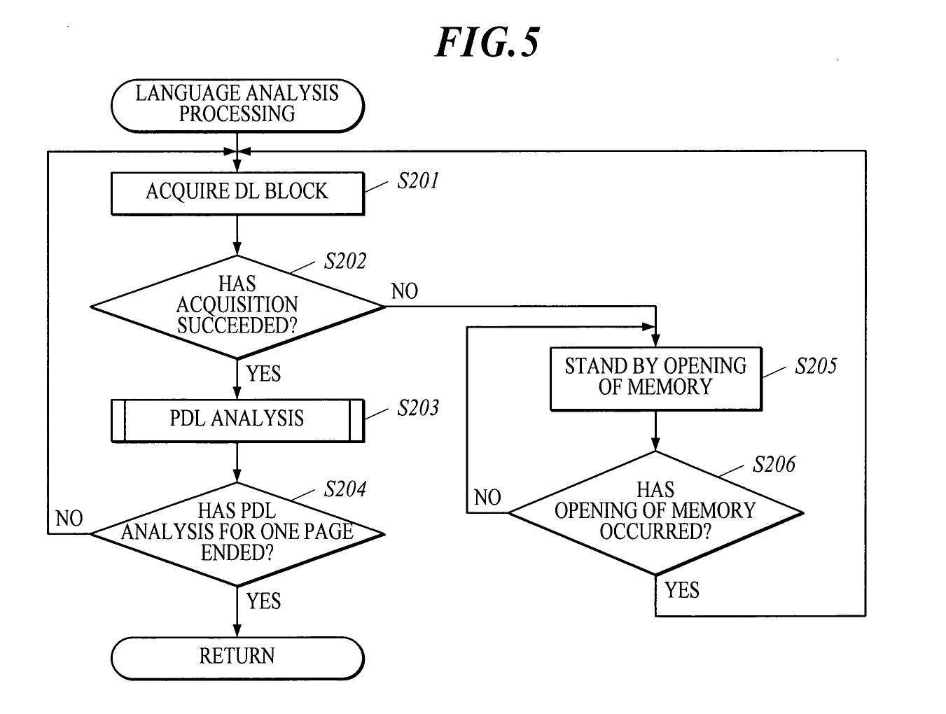

The language analysis unit 111 is the function unit that reads the spool data 120 temporarily stored in the spool buffer 115 and performs the language analysis processing thereof to produce the display list 121, which is the data expressed in an intermediate language. The display list 121 is the data storing the rendering data converted from the PDL data 101 as image data, character bit map data, graphic elements or the like. The processing operation of the language analysis unit 111 is described in detail with reference to the flow chart shown in FIG. 5.

First, the language analysis unit 111 acquires a display list block (a memory area having a fixed size) that temporarily stores the display list 121 produced as an analysis result from the display list/band sharing save area 116 at Step S201. The language analysis unit 111 judges whether the language analysis unit 111 has acquired the display list block or not at Step S202. When the language analysis unit 111 has acquired the display list block, the language analysis unit 111 advances the processing to that at Step S203 (Step S202: YES). When the language analysis unit 111 has not been able to acquire the display list block, the language analysis unit 111 advances the processing to that at Step S205, and stands by until the area of the memory equal to the size of the display list block is opened (Step S202: NO). When the area of the memory equal to the size of the display list block is opened at Step S206, the language analysis unit 111 returns the processing to that at the Step S201 (Step S206: YES), and executes the acquisition processing of the display list block again.

The language analysis unit 111 executes “image processing (PDL analysis)” to produce the display list 121, and stores the produced display list 121 into the display list block at the Step S203. The language analysis unit 111 judges whether the analysis for a page has ended or not at Step S204. When the analysis has ended, the language analysis unit 111 exits from the present flow (Step S204: YES). When the analysis has not ended, the language analysis unit 111 returns the processing to that at the Step S201 (Step S204: NO). That is, when the display list block acquired at the Step S201 comes to have no space, the language analysis unit 111 acquires a new display list block to execute the “image processing (PDL analysis).”

In addition, the concrete description of the “image processing (PDL analysis)” at the Step S203 will be given later.

### [Rasterization Unit/Rasterization Processing (Step S103)]

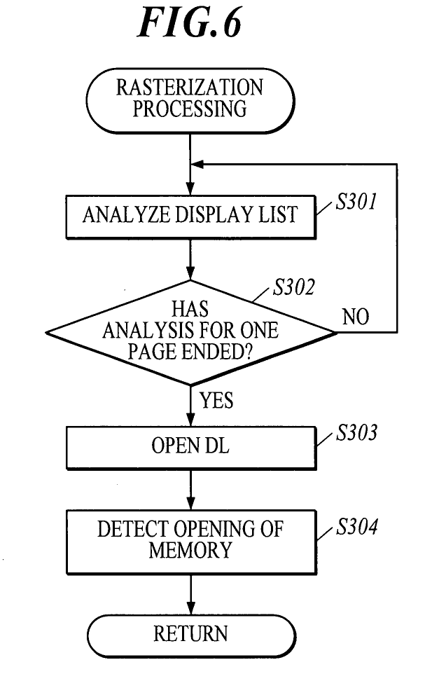

The rasterization unit 112 is the function unit performing rasterization processing to the display list data 121 to generate the multivalued bit map data 122 per band. The processing operation of the rasterization unit 112 is described in detail with reference to the flow chart shown in FIG. 6.

The rasterization unit 112 reads the display list 121 from the display list/band sharing save area 116 to generate the multivalued (8-bits/pixel) bit map data 122 at the time point when the language analysis unit 111 has generated the display list 121 for a page at Step S301. To put it more minutely, the rasterization unit 112 equally divides the display list 121 for a page to generate band bit map data per band.

The rasterization unit 112 judges whether the generation of the multivalued bit map data 122 for a page has ended or not at Step S302. When the generation has not ended, the rasterization unit 112 returns the processing to that at Step S301 (Step S302: NO). When the generation of the multivalued bit map data 122 for a page has ended, the rasterization unit 112 advances the processing to that at Step S303 (Step S302: YES).

The rasterization unit 112 erases the display list 121 for a page from which the multivalued bit map data 122 has been generated from the display list/band sharing save area 116 at the Step S303.

### [Screen Processing Unit/Screen Processing (Step S104)]

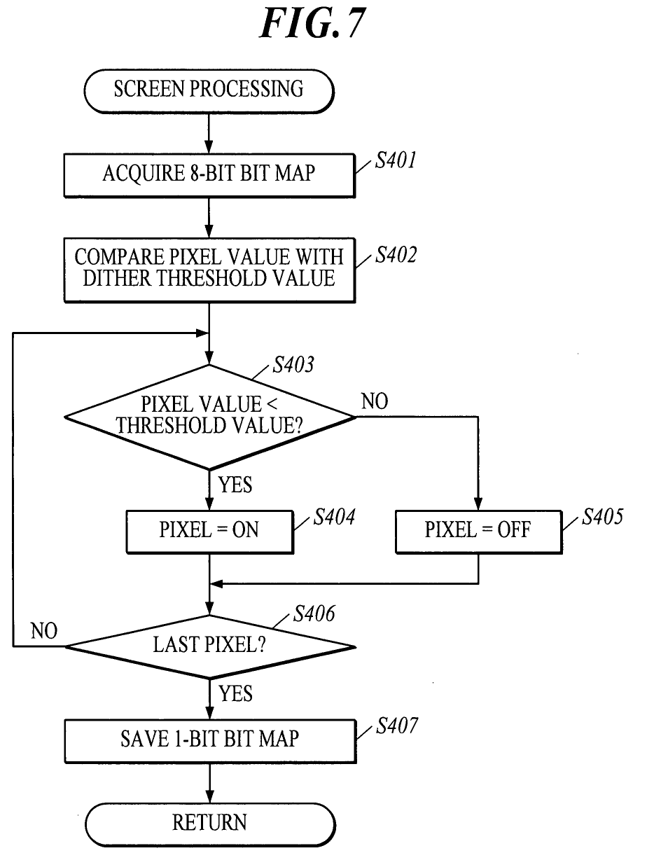

The screen processing unit 113 is the function unit comparing the multivalued bit map data 122 of 8-bits/pixel to each color, which has been generated by the rasterization unit 112, with an unshown dither threshold value table at each pixel to generate the binary bit map data 123 of 1-bit/pixel. The binary bit map data 123 is the data expressing the fill having the narrowest bit intervals (or having no bit intervals), which is the so-called “solid”. The processing operation of the screen processing unit 113 is described with reference to the flow chart shown in FIG. 7.

The screen processing unit 113 reads the multivalued bit map data 122 of 8-bits/pixel to each color, which has been generated by the rasterization unit 112, from the display list/band sharing save area 116 at Step S401.

The screen processing unit 113 compares the multivalued bit map data 122 with an unshown dither threshold value table at each pixel at Step S402, and judges whether the pixel value is smaller than the dither threshold value or not. When the pixel value is smaller than the dither threshold value, the screen processing unit 113 advances the processing to that at Step S404 (Step S403: YES). When the pixel value is not smaller than the dither threshold value, the screen processing unit 113 advances the processing to that at Step S405 (Step S403: NO).

The screen processing unit 113 turns on the pixel having the pixel value smaller than the dither threshold value at the Step S404. On the other hand, the screen processing unit 113 turns off the pixel having the pixel value not smaller than the dither threshold value at the Step S405. That is, the screen processing unit 113 performs the processing of generating 1-bit/pixel binary bit map data 123 from the 8-bits/pixel multivalued bit map data 122 by the processing at the Steps S403, S404 and S405.

The screen processing unit 113 judges whether the processing has been performed to all the pixels or not at Step S406. When the screen processing unit 113 judges that the processing has been performed to all the pixels, the screen processing unit 113 advances the processing to that at Step S407 (Step S406: YES). When the screen processing unit 113 judges that the processing has not been performed to all the pixels yet, the screen processing unit 113 returns the processing to that at the Step S403, and continues the processing until the processing has been performed to all the pixels.

The screen processing unit 113 temporarily stores the binary bit map data 123 in the display list/band sharing save area 116 at the Step S407.

### [Image Formation Control Unit (Step S105)]

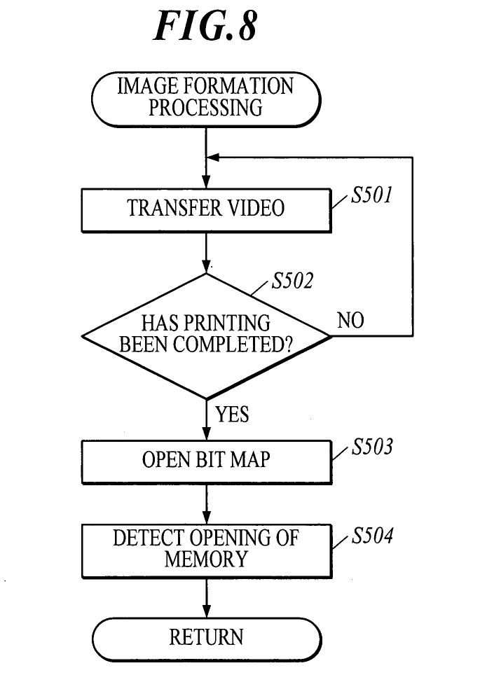

The image formation control unit 105 is the function unit of reading the binary bit map data 123 generated in the screen processing unit 113 from the display list/band sharing save area 116 to perform video transfer to the image formation unit 80. The processing operation of the image formation control unit 105 is described with reference to the flow chart of FIG. 8.

The image formation control unit 105 reads the 1-bit/pixel binary bit map data 123 from the display list/band sharing save area 116 to transfer the read binary bit map data 123 to the image formation unit 80 at Step S501. The image formation control unit 105 repeats the processing until the binary bit map data 123 for a page ends.

The image formation unit 80 performs image formation on a sheet of record paper based on the binary bit map data 123 for a page, and the image formation control unit 105 judges whether the image formation processing for a page has ended or not at Step S502. When the image formation control unit 105 judges that all the image formation processing has ended, the image formation control unit 105 advances the processing to that at Step S503 (Step S502: YES). When the image formation control unit 105 judges that the image formation processing has not been ended yet, the image formation control unit 105 returns the processing to that at the Step S501.

When the image formation processing for a page has ended, the image formation control unit 105 erases the binary bit map data 123 for a page from the display list/band sharing save area 116 at the Step S503 (bit map opening).

The MFP 1 is configured to perform image formation on a sheet of record paper in accordance with the aforesaid image formation processing.

Next, the “image processing (PDL analysis)” (see the Step S203 of the FIG. 5), which is the most characteristic part of the MFP 1, is described.

### [Outline of Image Processing]

The image processing of the MFP 1 is executed mainly by the aforesaid language analysis unit 111. In the image forming apparatus performing image formation based on bit map data, the filling portions in the PDL data 101 is expressed by, for example, pattern data such as a checkered pattern. Consequently, moiré (interference fringes) is caused related to a pattern period of the dots subjected to dither processing. Accordingly, when a rendering command of specifying filling with an “overwriting pattern” or an “pattern mask” is described with the PDL data 101, the MFP 1 is configured not to perform the expression with the pattern data, but to replace the rendering command of specifying the filling of a uniform density in which gradations and the like have been changed in order to prevent the occurrence of the moiré. That is, the MFP 1 is configured to remove the interference of a pattern and the dots that have been subjected to the dither processing, which is the cause of the moiré, itself by changing the pattern data into the filling data of a binary bit map.

### [Re Overwriting Pattern and Pattern Mask]

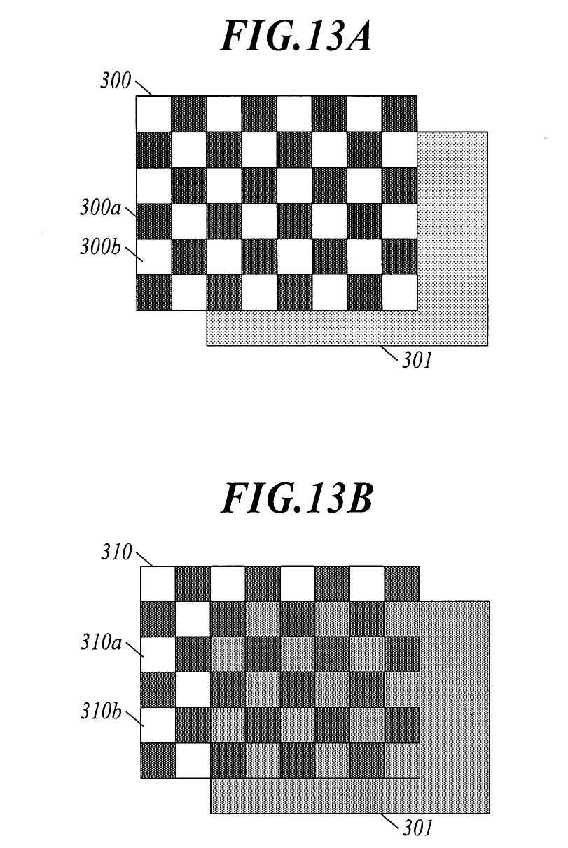

In the following, the processing of the “overwriting pattern” and the processing of the “pattern mask”, which are the pattern data to be applied in the present embodiment, are described before the concrete processing of the “image processing” is described. FIG. 13A is a schematic view showing an example of the “overwriting pattern”, and FIG. 13B is a schematic view showing an example of the “pattern mask.” In addition, it is supposed that the pattern of the checkered pattern (hereinafter referred to as a “tile pattern” is applied also to the processing of the “overwriting pattern” and the processing of the “pattern mask.”

In the FIG. 13A, an overwriting pattern 300 is expressed by low gradation areas 300a constructed of the bit map having the gradation of high density (low gradation) and high gradation areas 300b constructed of the bit map having the gradation of low density (high gradation). A ground bit map 301 is a bit map image to be printed on a record medium before the overwriting pattern 300.

Both of the low gradation areas 300a and the high gradation areas 300b of the overwriting pattern 300 are printed without being influenced by the ground bit map 301. That is, the overwriting processing of the overwriting pattern 300 is performed to the ground bit map 301.

In the FIG. 13B, a pattern mask 310 is expressed by low gradation areas 310a and ground preferential areas 310b. The pattern mask 310 is designed so that, when the pattern mask 310 is superposed on the ground bit map 301, the low gradation areas 310a are expressed as they are, but that the ground bit map 301 is expressed in the ground preferential areas 310b.

### [Details of Image Processing]

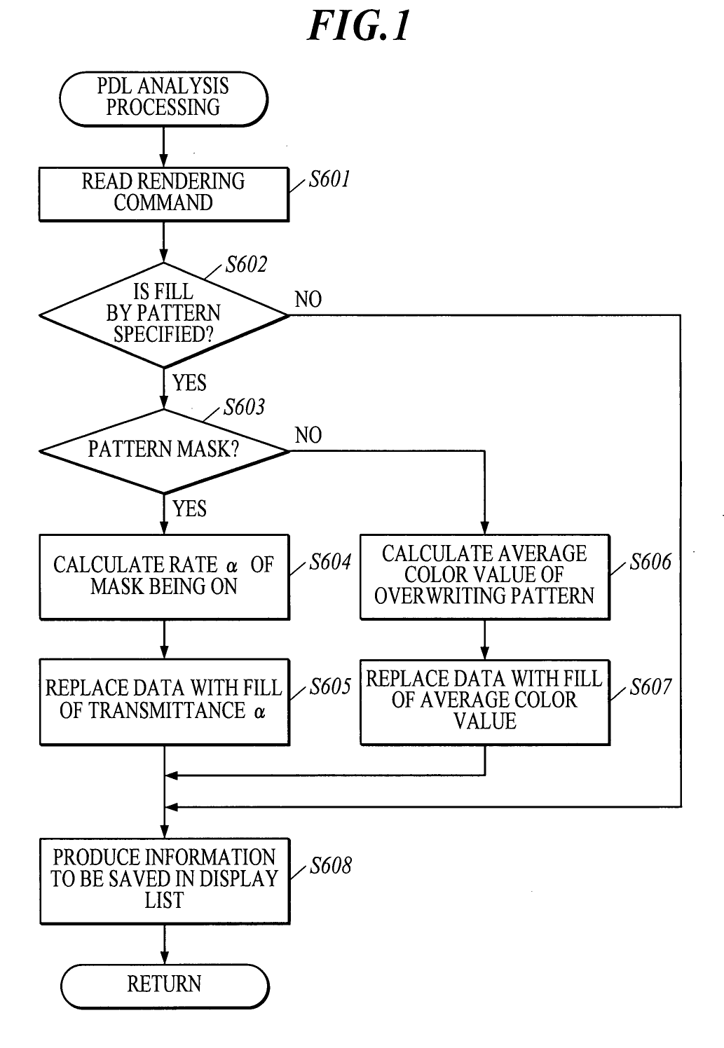

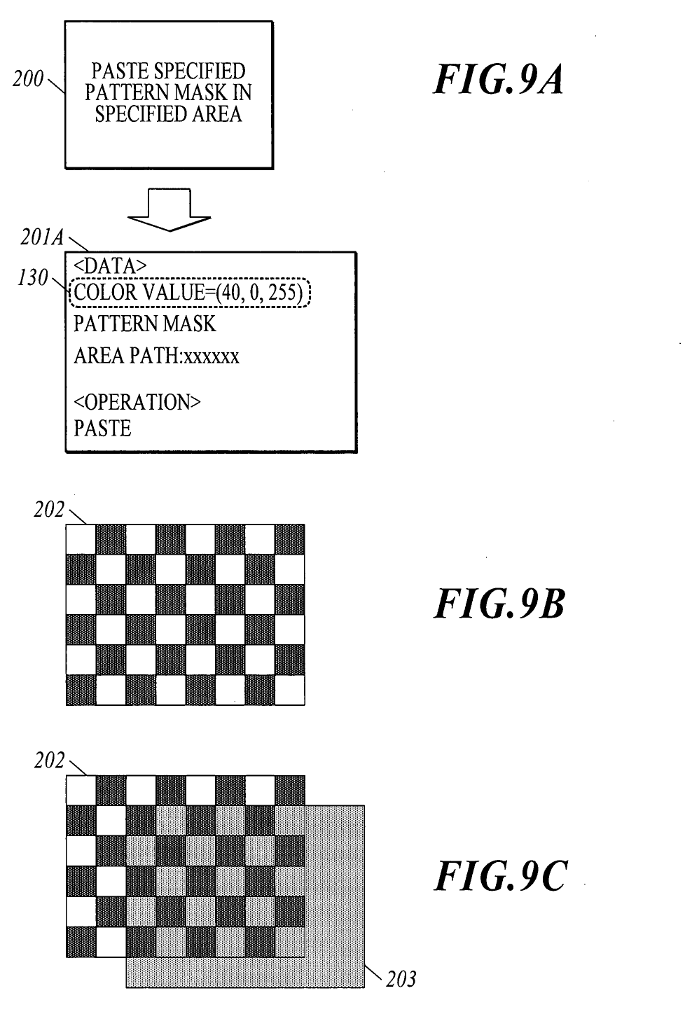

Next, the procedure of the “image processing” is described in detail with reference to FIG. 1. Moreover, it is supposed that the description is given using the examples of the aforesaid “overwriting pattern” and the “pattern mask” in the following processing. Moreover, the schematic views shown in FIGS. 9A-12C show conventional examples and the examples in the present embodiment in the processing of the “overwriting pattern” and the “pattern mask.”

In addition, the following processing is mainly executed by the language analysis unit 111 of the control unit 10 in accordance with the instructions of a program.

The language analysis unit 111 reads a rendering command from the spool data 120 (PDL data) temporarily recorded in the spool buffer 115 at Step S601.

The language analysis unit 111 analyzes the read rendering command to judge whether the rendering command is the specification of filling by a pattern or not at Step S602. When the language analysis unit 111 judges that the rendering command is not the specification of filling by a pattern, the language analysis unit 111 advances the processing to that at Step S608 (Step S602: NO). When the language analysis unit 111 judges that the rendering command is the specification of filling by a pattern, the language analysis unit 111 advances the processing to that at Step S603 (Step S602: YES).

The language analysis unit 111 further judges whether the specification of filling by a pattern is that of using the “pattern mask” or not at the Step S603. When the language analysis unit 111 judges that the specification of filling is that of using the “pattern mask”, the language analysis unit 111 advances the processing to that at Step S604 (Step S603: YES). When the language analysis unit 111 judges that the specification of filling is not that of using the “pattern mask” (namely, that of using the “overwriting pattern”), the language analysis unit 111 advances the processing to that at Step S606 (Step S603: NO). In the following, the processing at the Steps S604 and S605 expresses the processing in the case where the specification of filling is that of using the “pattern mask”, and the processing at the Steps S606 and S607 expresses the processing in the case where the specification of filling is that of using the “overwriting pattern.”

First, the processing in the case where the specification of filling is that of using the “pattern mask” is described.

FIG. 9A shows a rendering command 200 included in the PDL data 101, which rendering command 200 describes the (attribute) information of “rendering a specified pattern mask in a specified area.” Moreover, a reference numeral 201A denotes a rendering command described in the display list/band sharing save area 116.

The rendering command 201A describes the “pattern mask” as the (attribute) information of performing the filling using the “pattern mask”, and describes the area to be filled as an “area path: xxxxxx.” In addition, it is supposed that the color values 130 (red (R), green (G), blue (B)) of the specified pattern mask are (R, G, B)=(40, 0, 255) as shown in FIG. 9A.

Furthermore, the rendering command 201A describes “paste” as an operation (method). The FIG. 9B shows a bit map pattern mask 202 expanded as a bit map by executing those pieces of information. FIG. 9C is a schematic view showing the state of a result of the pattern mask processing using the bit map pattern mask 202 on a ground bit map 203 subjected to image formation on a sheet of record paper in advance.

The language analysis unit 111 performs the operation shown in the following formula 1, and obtains the rate of pixels that are turned on per a unit area (M×N) of the pattern mask to calculate the rate as a transmittance α at the Step S604.

Transmittance α(%)=(Number of pixels being on per unit area)/(Total number of pixels per unit area) Formula 1

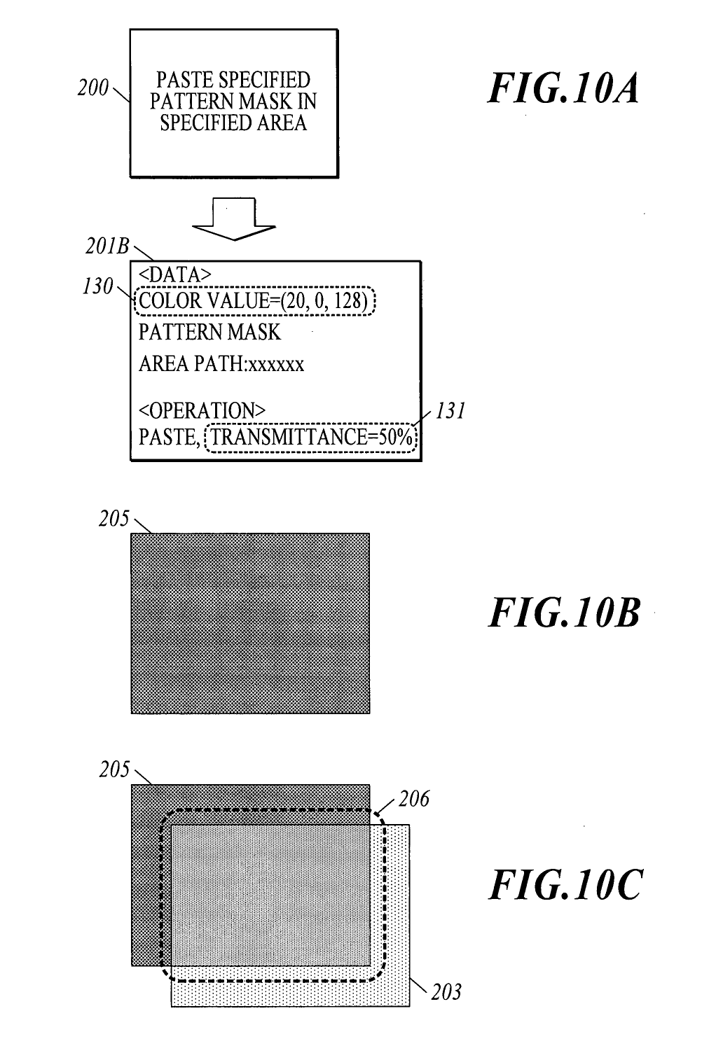

That is, the color values expressed by the “pattern mask” can be defined by obtaining the rate of the number of the pixels that are turned on in the unit area (M×N). For example, in the case of the transmittance α=50%, the color values 130 are (R, G, B)=(20, 0, 128) as shown in FIG. 10A.

The language analysis unit 111 performs the processing of replacing (changing) the data in the parts specified to perform pattern masking in a rendering command 201B with the filling processing using the color values calculated based on the transmittance α at Step S605.

After that, the language analysis unit 111 describes the information to be recorded in the display list 121 (“color value=(20, 0, 128)”, “pattern mask”, “path (range)”, “fill”, “transmittance=50%” and the like) into the display list 121 (see FIG. 10A), and temporarily records the information into the display list/band sharing save area 116 (see the display list 121 in FIG. 3) at the Step S608.

FIG. 10B schematically shows a bit map pattern mask 205 in the case of specifying the filling using a binary bit map with color values 130=(40, 0, 255). FIG. 10C schematically shows the state of masking the ground bit map 203 with the bit map pattern mask 205. The mask areas 206 in which the pattern mask 205 is superposed on the ground bit map 203 are filled by the binary bit map having the color values of (20, 0, 128).

Next, the processing in the case where the specification of filling is that of using the “overwriting pattern” is described.

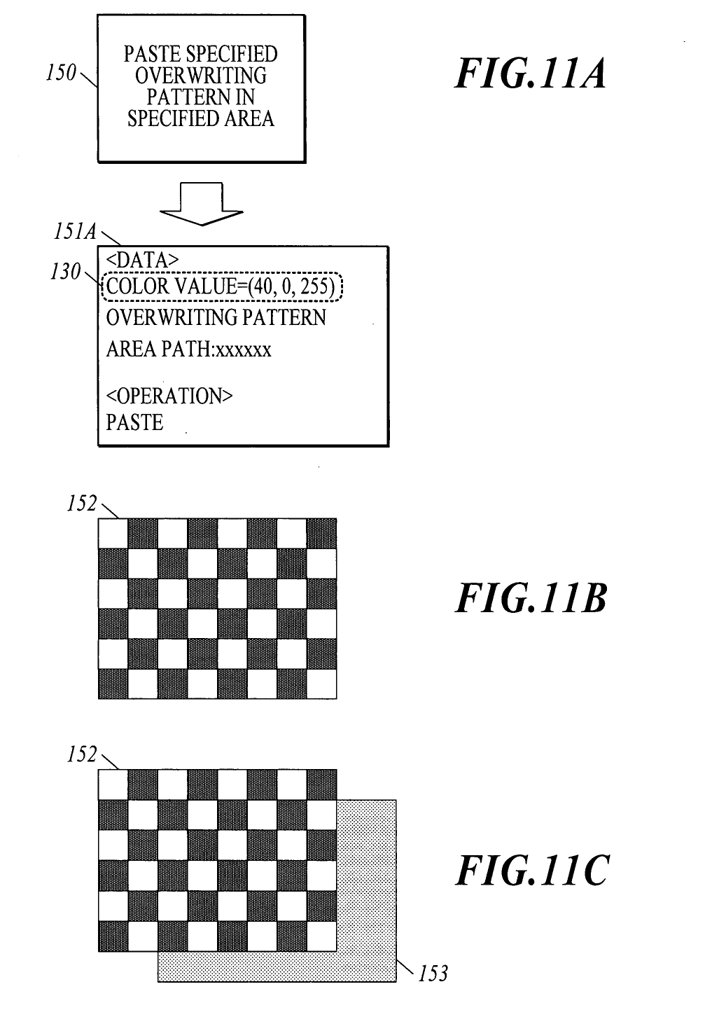

FIG. 11 shows conventional filling processing using the “overwriting pattern.” FIG. 11A shows a rendering command 150 included in the PDL data 101, and the rendering command 150 describes the information of “rendering (pasting) a specified overwriting pattern in a specified area.” Moreover, a reference numeral 151A denotes a rendering command described in the display list/band sharing save area 116.

The rendering command 151A describes the “pattern” as the (attribute) information of performing the filling using the “overwriting pattern”, and describes the area to be filled as an “area path: xxxxxx.” In addition, it is supposed that the color values 130 of the specified overwriting pattern are (R, G, B)=(40, 0, 255) as shown in FIG. 11A.

Furthermore, the rendering command 151A describes “paste” as an operation (method). The FIG. 11B shows a bit map pattern mask 152 expanded as a bit map by executing those pieces of information. FIG. 11C is a schematic view showing the state of a result of the filling processing by the pattern using a bit map overwriting pattern 152 on a ground bit map 153 subjected to image formation on a sheet of record paper in advance.

The language analysis unit 111 performs the operation shown in the following formula 2, and obtains the average color value of the pattern at the Step S606.

Average color value=(Color values of pattern specifying)×(Rate of pixels turned on per unit area) Formula 2

That is, the rate of the pixels that are turned on per unit area can be obtained by counting the number of pixels that are severally turned on and off, and the color values expressed by the overwriting pattern can be defined. The value obtained by multiplying the value by the color values (R, G, B)=(40, 0, 255) is set as the average color value.

The language analysis unit 111 performs the processing of replacing the data in the parts specified as the overwriting patterns in the rendering command with the filling processing using the average color value at Step S607.

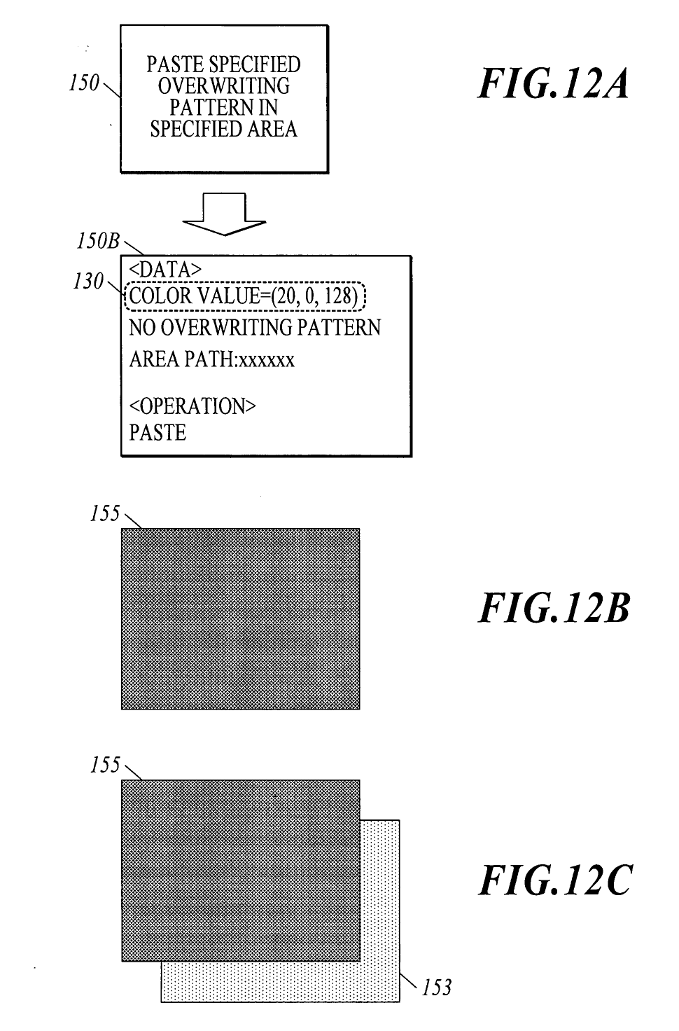

After that, the language analysis unit 111 describes the information to be recorded in the display list 121 (such as “color value=(20, 0, 128)”, “no pattern”, “path (range)”, “fill” and the like) in the display list 121 (see FIG. 12A), and temporarily records the information into the display list/band sharing save area 116 (see the display list 121 in FIG. 3) at the Step S608.

FIG. 12B schematically shows a bit map pattern 155 of the color values 130=(20, 0, 128). FIG. 12C schematically shows the state of filling the bit map pattern 155 with the ground bit map 153.

As described above, according to the MFP 1 to which the present invention is applied, the occurrence of the moiré caused related to the dither can be prevented. That is, pattern processing and pattern mask processing have been performed at the time of image formation in filling areas, but the occurrence of the moiré caused by the interference of the “overwriting pattern” and the “pattern mask” with a screen pattern can be prevented by replacing (changing) the pattern processing and the pattern mask processing with the filling processing using a uniform density pattern.

In particular, when the pattern processing and the pattern mask processing are replaced (changed) with the filling processing using the uniform density pattern, the rendering command of the spool data 120 is analyzed, and the rendering command specifying the filling using the “overwriting pattern” and the “pattern mask” is replaced (changed) with the rendering command specifying the uniform density filling. Consequently, the areas to which the filling processing of an image is performed and the density of filling can be specified with high accuracy.

Moreover, when “overwriting pattern” processing and “pattern mask” processing are replaced (changed) with the filling processing using a multivalued bit map, a multivalued bit map is newly generated based on a transmittance and an average color value to execute the filling processing. Consequently, the occurrence of moiré can be prevented without changing a visual gradation.

Furthermore, the MFP 1 is configured to detect the specification of filling by using the “overwriting pattern” or the “pattern mask” directly from the input PDL data 101 when the MFP 1 replaces (changes) the “overwriting pattern” specification and the “pattern mask” specification by a rendering command with the specification of filling by using a multivalued bit map. The image forming apparatus described in the Patent Document 1, which has been cited as a conventional example, is configured to detect a pattern from bit map data by pattern matching. When a pattern is extracted based on a bit map like the image forming apparatus described in the Patent Document 1, it is impossible to extract filling areas by the pattern completely. On the contrary, the MFP 1 of the present embodiment detects the specification of filling by using the “overwriting pattern” and the “pattern mask” from the PDL data 101 itself, and performs the replacement (change) of the detected areas with the specification of filling using multivalued bit map data. Consequently, the MFP 1 has an excellent advantage capable of improving the accuracy of specifying the areas to be replaced (changed) by leaps and bounds.

Although the MFP 1 to which the present invention is applied has been described in the above, the present invention is not limited to the various examples described above.

What is claimed is:

1. An image forming apparatus, comprising:
an image processing unit to generate multivalued data from an object included in print data in which a rendering command specifies filling of the object with a pattern, the object being subject to filling in a uniform density in the multivalued data, and to generate a bit map data which reproduces a halftone in a pseudo manner with a screen pattern from the multivalued data; and
an image formation control unit to form an image on a recording medium based on the bit map data.

2. The image forming apparatus of claim 1, wherein the image processing unit comprises:
an analysis unit to change a rendering command of specifying filling with an overwriting pattern to that of specifying filling with multivalued data of uniform density, when the rendering command of specifying the filling with the pattern specifies the filling with the overwriting pattern;
a multivalued data processing unit to generate the multivalued data based on the specification of the filling with the multivalued data of uniform density; and
a screen processing unit to generate the bit map data which reproduces a halftone in a pseudo manner with a screen pattern from the multivalued data generated by the multivalued data processing unit.

3. The image forming apparatus of claim 1, wherein the uniform density is an intermediate of the overwriting pattern.

4. The image forming apparatus of claim 3, wherein the intermediate tone is an average tone of pixels included in the overwriting pattern.

5. The image forming apparatus of claim 1, wherein the image processing unit comprises:
an analysis unit to change a rendering command of specifying filling with a pattern mask to that of specifying filling with multivalued data of uniform density, when the rendering command of specifying the filling with the pattern specifies the filling with the pattern mask;
a multivalued data processing unit to generate the multivalued data based on the specification of the filling with the multivalued data of uniform density; and
a screen processing unit to generate the bit map data which reproduces a halftone in a pseudo manner with a screen pattern from the multivalued data generated by the multivalued data processing unit.

6. The image forming apparatus of claim 5, wherein the uniform density is defined based on a transmittance of the pattern mask.

7. The image forming apparatus of claim 6, wherein the transmittance is defined based on the number of pixels which is turned on in the pattern mask.

8. An image forming method, comprising:
an image processing step to generate multivalued data from an object included in print data in which a rendering command specifies filling of the object with a pattern, the object being subject to filling in a uniform density in the multivalued data, and to generate a bit map data which reproduces a halftone in a pseudo manner with a screen pattern from the multivalued data; and
an image formation control step to form an image on a recording medium based on the bit map data.

9. The image forming method of claim 8, wherein the image processing step comprises:
an analysis step to change a rendering command of specifying filling with an overwriting pattern to that of specifying filling with multivalued data of uniform density, when the rendering command of specifying the filling with the pattern specifies the filling with the overwriting pattern;
a multivalued data processing step to generate the multivalued data based on the specification of the filling with the multivalued data of uniform density; and
a screen processing step to generate the bit map data which reproduces a halftone in a pseudo manner with a screen pattern from the multivalued data generated in the multivalued data processing step.

10. The image forming method of claim 8, wherein the uniform density is an intermediate of the overwriting pattern.

11. The image forming method of claim 10, wherein the intermediate tone is an average tone of pixels included in the overwriting pattern.

12. The image forming method of claim 8, wherein the image processing step comprises:
an analysis step to change a rendering command of specifying filling with a pattern mask to that of specifying filling with multivalued data of uniform density, when the rendering command of specifying the filling with the pattern specifies the filling with the pattern mask;
a multivalued data processing step to generate the multivalued data based on the specification of the filling with the multivalued data of uniform density; and
a screen processing step to generate the bit map data which reproduces a halftone in a pseudo manner with a screen pattern from the multivalued data generated in the multivalued data processing step.

13. The image forming method of claim 12, wherein the uniform density is defined based on a transmittance of the pattern mask.

14. The image forming method of claim 13, wherein the transmittance is defined based on the number of pixels which is turned on in the pattern mask.

15. A computer readable medium which stores a program causing a computer to realize the functions of:
an image processing function to generate multivalued data from an object included in print data in which a rendering command specifies filling of the object with a pattern, the object being subject to filling in a uniform density in the multivalued data, and to generate a bit map data which reproduces a halftone in a pseudo manner with a screen pattern from the multivalued data; and
an image formation control function to form an image on a recording medium based on the bit map data.

16. The computer readable medium of claim 15, wherein the image processing function comprises:
an analysis function to change a rendering command of specifying filling with an overwriting pattern to that of specifying filling with multivalued data of uniform density, when the rendering command of specifying the filling with the pattern specifies the filling with the overwriting pattern;
a multivalued data processing function to generate the multivalued data based on the specification of the filling with the multivalued data of uniform density; and
a screen processing function to generate the bit map data which reproduces a halftone in a pseudo manner with a screen pattern from the multivalued data generated by the multivalued data processing function.

17. The computer readable medium of claim 15, wherein the uniform density is an intermediate of the overwriting pattern.

18. The computer readable medium of claim 17, wherein the intermediate tone is an average tone of pixels included in the overwriting pattern.

19. The computer readable medium of claim 1, wherein the image processing function comprises:
an analysis function to change a rendering command of specifying filling with a pattern mask to that of specifying filling with multivalued data of uniform density, when the rendering command of specifying the filling with the pattern specifies the filling with the pattern mask;
a multivalued data processing function to generate the multivalued data based on the specification of the filling with the multivalued data of uniform density; and
a screen processing function to generate the bit map data which reproduces a halftone in a pseudo manner with a screen pattern from the multivalued data generated by the multivalued data processing function.

20. The computer readable medium of claim 19, wherein the uniform density is defined based on a transmittance of the pattern mask.

21. The computer readable medium of claim 20, wherein the transmittance is defined based on the number of pixels which is turned on in the pattern mask.
